(19) United States
(12) Patent Application Publication
(10) Pub. No.: US 2014/0019210 A1
(43) Pub. Date: Jan. 16, 2014

(54) DETERMINING PRODUCT PRICE

(71) Applicants: Jose Luis Beltran Guerrero, Mountain View, CA (US); Ruxian Wang, Mountain View, CA (US); Enis Kayis, East Palo Alto, CA (US); Guillermo Gallego, Waldwick, NJ (US); Jianqiang Wang, Mountain View, CA (US); Kay-Yut Chen, Santa Clara, CA (US); Shailendra K. Jain, Cupertino, CA (US)

(72) Inventors: Jose Luis Beltran Guerrero, Mountain View, CA (US); Ruxian Wang, Mountain View, CA (US); Enis Kayis, East Palo Alto, CA (US); Guillermo Gallego, Waldwick, NJ (US); Jianqiang Wang, Mountain View, CA (US); Kay-Yut Chen, Santa Clara, CA (US); Shailendra K. Jain, Cupertino, CA (US)

(21) Appl. No.: 13/547,804

(22) Filed: Jul. 12, 2012

(51) Int. Cl. G06Q 10/00

(52) U.S. Cl. 705/7.35

(57) ABSTRACT

Methods, systems, and computer-readable and executable instructions are provided for determining a product price. Determining a product price can include determining an initial market attraction value, a market price sensitivity, and cost information for a product. Determining a product price can also include receiving a market constraint with respect to the product and pricing the product based on the initial market attraction value, the market price sensitivity, the cost information, and the market constraint.

### BACKGROUND

Manufacturers are driven to compete in a marketplace in order to obtain a desired profit, target a market share, and/or aim at a balanced combination of both. Pressure to compete can be caused by competition and a decrease in profit margins or a loss in market share. Pricing may be used to drive demand in the manufacturers' desired direction.

### BRIEF DESCRIPTION OF THE DRAWINGS

FIG. 1 is a block diagram illustrating an example of a method for determining a product price according to the present disclosure.

FIG. 2 is a block diagram illustrating an example of a method for determining a product price according to the present disclosure.

FIG. 3 illustrates an example computing device according to an example of the present disclosure.

### DETAILED DESCRIPTION

Examples of the present disclosure may include methods, systems, and computer-readable and executable instructions and/or logic. An example method for determining a product can include determining an initial market attraction value, a market price sensitivity, and cost information for a product and receiving a market constraint with respect to the product. An example method can also include pricing the product based on the initial market attraction value, the market price sensitivity, the cost information, and the market constraint.

To attract customers and earn profit, firms (e.g., manufacturers, companies, etc.) may offer multiple differentiated substitutable products and adopt different pricing strategies. Customers may choose among a variety of competing goods based on features, quality, brand, price, etc. Product pricing can be an important factor in driving demand in a desired direction. Product pricing can include gathering customer and product information, as well obtaining a constraint and/or constraints relating to the product. Using this information, a product and/or products can be priced such that a company can increase (e.g., maximize) profits for the product and/or products. Profit optimization, also known as profit maximization, can include a process by which an organization determines a price and/or prices for a product portfolio and output level that return a greatest profit.

Product pricing and price optimization can include an estimation (e.g., an accurate estimation) of how product demand varies at different price levels and combine the information with data on product costs and inventory levels to determine prices that may improve profits. Product pricing and price optimization can include tailoring pricing for customer market segments by simulating how targeted customers may respond to price changes on a product or any substitute product (e.g., a product which, as a result of changed conditions, may replace another product in use), as well as changes to other factors, for example.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P”, “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

A Multinomial Logit (MNL) discrete choice model can be used to predict probabilities of different possible outcomes of a categorically distributed dependent variable, given a set of independent variables. The MNL model can be derived from an underlying random utility model, which can be based on a probabilistic model of individual customer utility, which can model customers with inherently unpredictable behavior, and as a result, can show probabilistic tendency for a customer to prefer one alternative to another in a set of alternative (e.g., relevant alternative) choices, including a non-alternative choice. For example, if there is a random part of customers' utility, or a firm has only probabilistic information on the utility function of any given customer, the MNL model can describe customers' purchase behavior.

For example, let αᵢ be a base utility of product i. Utility can include, for example, an amount of customer desire that a product will satisfy, at a certain place and time, or how much a customer is willing to pay for the product. Let βᵢ be a price sensitivity (e.g., a degree to which a product's price affects customers' purchasing behaviors) and a₀ be an attraction of outside opportunity, which can include attraction towards a competitor's products and/or a non-purchase option. If the customer purchase behavior follows the MNL model, a probability that a customer selects product i can be computed by:

$${d}_{i} ( p ) = \frac{{e}^{{α}_{i} - {β}_{i} {p}_{i}}}{{a}_{0} + {\sum }_{j = 1}^{N} {e}^{{α}_{j} - {β}_{j} {p}_{j}}} ,$$

where N is a number of available products in the market, p=(p₁, p₂, . . . , p_{N}) is a price vector of products, and e is the Euler constant, approximately 2.71828 for example. A manufacturer can select a price for each product to increase to its largest potential (e.g., maximize) for a total expected profit, and it can be formulated as follows:

$${max}_{p} ( p ) := {\sum }_{j = 1}^{N} ( {p}_{i} - {c}_{i} ) {d}_{i} ( p ) ,$$

such that,

$$0 \geq {\sum }_{i = 1}^{N} {d}_{i} ( p ) \geq \underline{d} .$$

where d is a constant less than 1.0.

A markup, defined by price subtracted by cost, can be constant for all the products in the optimal prices for the MNL model with identical price coefficients. In some embodiments, a result can be generalized for the MNL model with variant price coefficients.

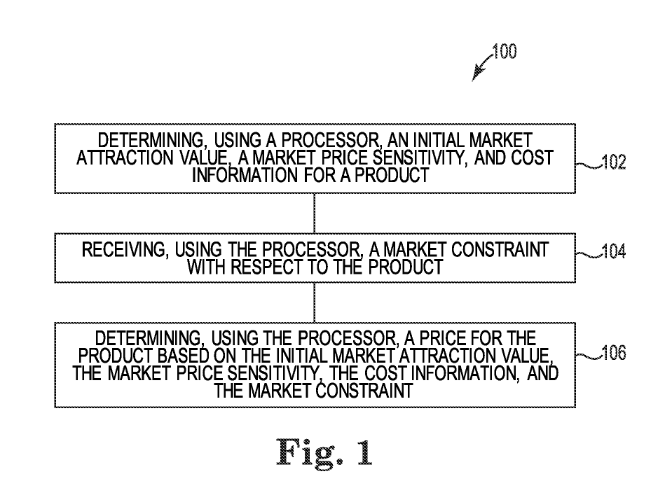

FIG. 1 is a block diagram illustrating an example of a method 100 for determining a product price according to the present disclosure. In some embodiments, method 100 can include a computer-implemented method performed by a processor and/or processors. Estimations can be made regarding a product's market share and probabilities that customers will purchase the product. Historical data can be gathered and organized. For example, information regarding the product's price, similar products' prices, competitors' prices, brands, product features, etc. can be gathered. In some embodiments, the information can be gathered from an outside source.

At 102, an initial market attraction value, a market price sensitivity, and cost information for a product are determined. In some examples, the initial market attraction value, a market price sensitivity, and cost information can be stored in a database.

In a number of embodiments, the initial market attraction value, market price sensitivity, and cost information can be determined for a number of products and/or a product offering including multiple products. The initial market attraction value and the market price sensitivity for the product can be determined utilizing the gathered information, for example. An initial market attraction value can include, for example, customer attraction to the product and/or a desire to purchase the product. The initial market attraction value can be determined based on, for example, sales data, customer behavior data, and/or product variety data, among others. The initial market attraction can be determined for a particular market segment (e.g., age groups, genders, incomes, etc.) based on a market price sensitivity (e.g., a degree to which a product's price affects a customer's purchasing behaviors) and/or a brand value (e.g., a name-brand versus a generic brand value), for example. Cost information can include, among others, a cost of direct labor, direct materials, and/or manufacturing overhead that are consumed to create a product, for example. Cost information can also include a cost of labor required to deliver a service to a customer, for example.

A market constraint is received at 104. A market constraint can include, for example, something that prevents a system (e.g., an organization) from achieving more of its goal(s). Constraints can be internal or external to the system. An internal constraint can be in evidence when the market demands more from the system than it can deliver. If this is the case, then the focus of the organization may be on discovering that constraint and dealing with it. An external constraint can exist when the system can produce more than the market can bear. If this is the case, then the organization may focus on mechanisms to create more demand for its products or services.

Internal constraints can include, for example, equipment, people, and policy. A manner in which equipment is currently used may limit an ability of the system to produce more salable goods/services, for example. A lack of skilled people can limit the system. Mental models held by people can cause behavior that may become a constraint. A written or unwritten policy can be a constraint, for example, if it prevents the system from increasing profits.

Additionally, a market constraint can include an optimization constraint. In optimization, a constraint can be written into a mathematical expression to limit the scope of the solution (e.g., x can be no greater than 5). In some embodiments, the market constraint can include a market share constraint (e.g., a market share of a product is greater than 10 percent), a market price range constraint (e.g., an upper and/or lower bound for the price of a product), and/or a product quantity constraint (e.g., a product quantity cannot exceed 10,000 units because of resource limit) At 106, the price for the product is determined based on the initial market attraction value, the market price sensitivity, the cost information, and the market constraint.

In some embodiments, determining a product price can include determining a price of a product offering, with multiple products, and/or determining the price of the product offering to control an effect of price interaction among the multiple products in the offering set. A product price can be determined for each of a number of products simultaneously, for example.

In a number of embodiments, product pricing can be utilized by a company for analyzing and understanding particular segments of a business market and improving submarket segmenting. For example, a statistically estimated MNL model can indicate which product and/or products have increased price sensitivities, and as a result, an organization can create higher priced-lower utility market segments and lower priced-higher utility market segments. An organization can introduce new products into these segments at a desired (e.g., optimal) price. Additional, product pricing can be used by an organization to understand competitors' product offerings and prices, for example.

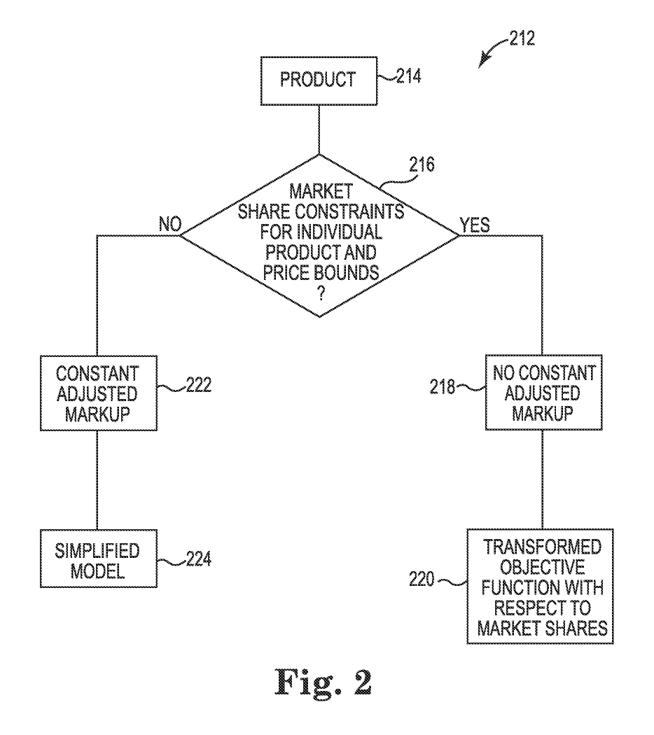

FIG. 2 is a block diagram illustrating an example of a method 212 for determining a product price according to the present disclosure. At 214, a product or a number of products can be analyzed, and market share constraints for individual product and price bounds can be considered at 216. A product can include, for example, an article or substance that is manufactured or refined for sale. The market constraints can include, for example a market share constraint, a market price range constraint, and/or a product range constraint, among others. Price bounds can include, for example, a market price range constraint.

If at 216, it is determined that market constraints and/or price bounds are present, it can be determined at 222 that the adjusted markup is constant at optimality for the product and/or number of products. Optimality can include, for example, a product price that returns a greatest profit. Product pricing can be determined with respect to an adjusted markup of the product and/or a market share of the product corresponding to the adjusted markup.

In some embodiments, if the adjusted markup (e.g., price minus cost minus the reciprocal of the price coefficient) is constant at optimality for a number of products analyzed, a multi-product price optimization model can be simplified to a model in a single-dimensional space (e.g., at 224). The simplified model can be used to determine a price for the product or number of products that will result in increased profits (e.g., maximized profits) for the product and/or number of products, as will be discussed further herein. Moreover, the simplified model may be uni-modal in the adjusted markup, which can result in a more efficient model to determine prices that increase (e.g., maximize) profits.

If, at 218, market constraints and/or price bounds are present, it can be determined that an adjusted markup is not constant at optimality for the product and/or number of products. The adjusted markup may not be constant if there are some constraints (e.g., market constraints) on prices and market shares for an individual product and/or a group of products. A transformed optimization model (e.g., a transformed objective function) can be considered at 220 with respect to market shares if the adjusted markup is not constant because there may be one-to-one mapping between prices and a market share vector. The transformed objective function can be jointly concave in market shares, and the transformed constraints can be linear. Concave optimization algorithms can be used to solve the transformed objective function, for example. Multi-product price optimization can be considered under an MNL discrete choice model in a number of embodiments.

Price optimization can be transformed to market share optimization because there is one-to-one mapping between prices and market shares under the MNL model. The transformation can be jointly concave with respect to market shares, and the price constraints can be transformed to linear constraints in market shares. Therefore, the concave optimization methods can solve the transformation with constraints on prices and market shares.

The adjusted markup, defined by the price minus the cost minus the reciprocal of the price coefficient, can be constant at optimal prices. For example,

$${p}_{j}^{*} - {c}_{j} - \frac{1}{{β}_{j}}$$

can be constant for all j=1, 2, . . . , N at an optimal price vector p*. An adjusted markup can be denoted as price minus cost minus the reciprocal of price sensitivity, or:

$$θ = {p}_{i} - {c}_{i} - \frac{1}{{β}_{i}} .$$

Then, the function can be reformulated as follows:

$${max}_{θ} R ( θ ) := {\sum }_{i = 1}^{N} ( θ + \frac{1}{{β}_{i}} ) {d}_{i} ( θ ) ,$$

such that,

$${\sum }_{i = 1}^{N} {d}_{i} ( θ ) \geq \underline{d} ,$$

where dᵢ is the market share of product i corresponding to adjusted markup θ. For example,

$${d}_{i} ( θ ) = \frac{{e}^{{\tilde{α}}_{i} - {β}_{i} θ}}{{a}_{0} + {\sum }_{j = 1}^{N} {e}^{{\tilde{a}}_{j} - {β}_{j} θ}} , \\ where$$

$${\tilde{α}}_{i} = {α}_{i} - {β}_{i} {c}_{i} - 1.$$

In some scenarios, it may be desirable to increase (e.g., maximize) a total market share or decrease (e.g., minimize) a competitor's profit subject to the constraints on total profit. In a general attraction model, of which the MNL model may be a special case, increasing (e.g., maximizing) a total market share or decreasing (e.g., minimizing) a competitor's profit subject to the constraints on profit R, can be equivalent to increasing (e.g., maximizing) a total attractiveness, which can be formulated as follows:

$${max}_{p} {\sum }_{i = 1}^{N} {e}^{{α}_{i} - {β}_{i} {p}_{i}} ,$$

such that,

$${\sum }_{i = 1}^{N} ( {p}_{i} - {c}_{i} ) {d}_{i} ( p ) \geq \underline{R} .$$

Similarly, the adjusted markups for the products can be constant at a price vector (e.g., an “optimal” price vector), and when optimizing over adjusted markup, the constraint,

$${\sum }_{i = 1}^{N} ( {p}_{i} - {c}_{i} ) {d}_{i} ( p ) \geq \underline{R} ,$$

can be equivalent to:

$$R ( θ ) := {\sum }_{i = 1}^{N} ( θ + \frac{1}{{β}_{i}} ) {d}_{i} ( θ ) \geq \underline{R} .$$

R(θ) can be unimodal in θ, and there can exist at most, for example, two solutions to R(θ)=R, denoted by θ and θ̅ and θ≦ θ̅ because the total attractiveness:

$${\sum }_{i = 1}^{N} {e}^{{α}_{i} - {β}_{i} {p}_{i}} , \\ or$$

$${\sum }_{i = 1}^{N} {e}^{{\overline{α}}_{i} - {β}_{i} θ} ,$$

(when optimizing over adjusted markup) is decreasing in prices pᵢ, as well as adjusted markup θ. An optimal adjusted markup, θ* may be a lower value (e.g., a minimum), such that it satisfies a profit constraint (e.g., θ*=θ). As such, the optimal solution to:

$${max}_{p} {\sum }_{i = 1}^{N} {e}^{{α}_{i} - {β}_{i} {p}_{i}} ,$$

such that,

$${\sum }_{i = 1}^{N} ( {p}_{i} - {c}_{i} ) {d}_{i} ( p ) \geq \underline{R} ,$$

can be expressed as follows:

$${p}_{j} = \underline{θ} + {c}_{j} + \frac{1}{{β}_{j}} .$$

However, the aforementioned approach may not apply when there are some constraints on prices and/or market shares, among others, for some individual products, as below:

$${max}_{p} R ( p ) := {\sum }_{i = 1}^{N} ( {p}_{i} - {c}_{i} ) {d}_{i} ( p ) ,$$

such that,

$${\sum }_{i = 1}^{N} {a}_{i} {d}_{i} ( p ) \geq b , {\underline{d}}_{i} \leq {d}_{i} ( p ) \leq {\overline{d}}_{i} , {∀}_{i} , {\underline{p}}_{i} \leq {\overline{p}}_{i} , {∀}_{i} ,$$

where the demand follows the MNL model as shown in:

$${d}_{i} ( p ) = \frac{{e}^{{α}_{i} - {β}_{i} {p}_{i}}}{{a}_{0} + {\sum }_{j = 1}^{N} {e}^{{α}_{j} - {β}_{j} {p}_{j}}} .$$

In some embodiments, constraints can be present due to practical lower and upper bounds on product prices, market shares of each product, and/or a total market share of an organization's entire product line vis-à-vis competitors, for example.

This can be a general multi-product price optimization problem with some general constraints, like:

$${\sum }_{i = 1}^{N} {a}_{i} {d}_{i} ( p ) \geq b$$

is a general joint constraint on market shares for some products.

The adjusted markup as shown above may not be constant and may not be straightforwardly simplified to a single variable problem, for example. An approach can be considered for the general MNL model with constraints on prices and market shares for individual products in some embodiments. There may be one-to-one mapping between price vector p:=(p₁, . . . , p_{N}) and market share vector d:=(d₁, . . . , d_{N}). From the MNL model,

$$\frac{{d}_{i}}{{d}_{o}} = \frac{{e}^{{α}_{i} - {β}_{i} {p}_{i}}}{{a}_{0}} , \\ then , \\ {p}_{i} = \frac{α - log {a}_{0}}{{β}_{i}} - \frac{1}{{β}_{i}} log \frac{{d}_{i}}{{d}_{0}}$$

which can show there is one-to-one mapping between price vector and market shares, where,

$${d}_{0} = 1 - {\sum }_{s = 1}^{N} {d}_{s} .$$

An objective function can be written as follows:

$$R ( d ) {=}^{def} {\sum }_{i = 1}^{M} ( \hat{α} - \frac{1}{{β}_{i}} log \frac{{d}_{i}}{1 - {\sum }_{s = 1}^{M} {d}_{s}} ) {d}_{i} , \\ where$$

$$\hat{α} = \frac{{α}_{i} - log {a}_{0}}{{β}_{i}} - {c}_{i} .$$

In an example, profit function R(d) is jointly concave in (d₁, . . . , d_{N}) in the domain

$$\{ ( {d}_{1} , … , {x}_{N} ) \text{:} 0 < {d}_{1} , … , {d}_{N} , {\sum }_{s = 1}^{N} {d}_{s} < 1 \} .$$

A multi-product price optimization under nonlinear constraints on prices and market shares under the MNL model can be transformed to a concave model (e.g., a concave maximization model) in market shares subject to some linear constraints:

$${max}_{d \geq 0} R ( d ) {=}^{def} {\sum }_{i = 1}^{N} ( \hat{α} - \frac{1}{{β}_{i}} log \frac{{d}_{i}}{1 - {\sum }_{i = 1}^{N} {d}_{i}} ) {d}_{i} ,$$

such that,

$${\sum }_{i = 1}^{N} {a}_{i} {d}_{i} ( p ) \geq b , \\ {\underline{d}}_{i} \leq {d}_{i} \leq {\overline{d}}_{i} , \\ {\underline{α}}_{i} {d}_{i} + {\sum }_{j \neq 1}^{ } {d}_{j} \leq 1 , \\ {\overline{α}}_{i} {d}_{i} + {\sum }_{j \neq 1}^{ } {d}_{j} \geq 1.$$

This can be a standard concave model (e.g., standard concave maximization model) because the objective function can be jointly concave, and all the constraints can be linear. It can be solved (e.g., solved efficiently) by methods, such as, for example, “interior-point methods,” “subgradient projection”, and/or “cutting-plane methods,” among others.

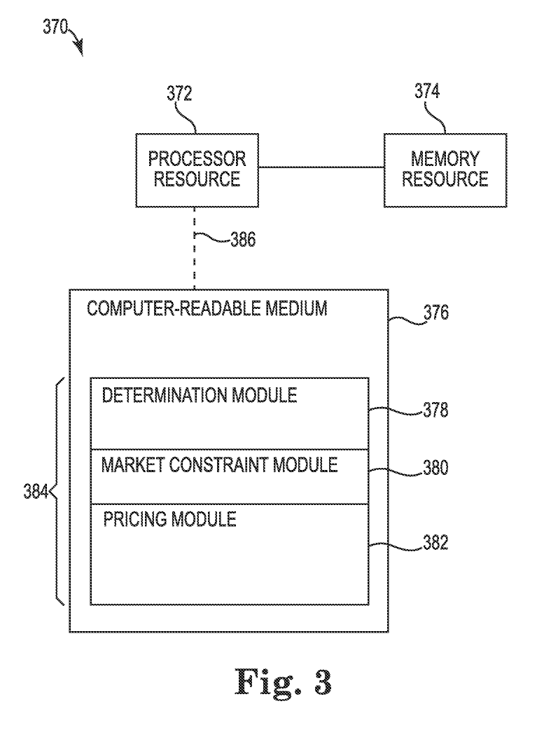

FIG. 3 illustrates an example computing device 370 according to an example of the present disclosure. The computing device 370 can utilize software, hardware, firmware, and/or logic to perform a number of functions.

The computing device 370 can be a combination of hardware and program instructions configured to perform a number of functions. The hardware, for example can include one or more processing resources 372, computer-readable medium (CRM) 376, etc. The program instructions (e.g., computer-readable instructions (CRI) 384) can include instructions stored on the CRM 376 and executable by the processing resources 372 to implement a desired function (e.g., augmenting memory capacity for a hyperscale computing system, etc.).

CRM 376 can be in communication with a number of processing resources of more or fewer than 372. The processing resources 372 can be in communication with a tangible non-transitory CRM 376 storing a set of CRI 384 executable by one or more of the processing resources 372, as described herein. The CRI 384 can also be stored in remote memory managed by a server and represent an installation package that can be downloaded, installed, and executed. The computing device 370 can include memory resources 374, and the processing resources 372 can be coupled to the memory resources 374.

Processing resources 372 can execute CRI 384 that can be stored on an internal or external non-transitory CRM 376. The processing resources 372 can execute CRI 384 to perform various functions, including the functions described in FIG. 1 and FIG. 2.

The CRI 384 can include a number of modules 378, 380, and 382. The number of modules 378, 380, and 382 can include CRI that when executed by the processing resources 372 can perform a number of functions.

The number of modules 378, 380, and 382 can be sub-modules of other modules. For example the receiving module 378 and the determination module 380 can be sub-modules and/or contained within a single module. Furthermore, the number of modules 378, 380, and 382 can comprise individual modules separate and distinct from one another.

A determination module 378 can comprise CRI 384 and can be executed by the processing resources 372 to determine a market price sensitivity, a cost, and a market utility of a product. A market constraint module 380 can comprise CRI 384 and can be executed by the processing resources 372 to receive a number of market constraints with respect to the product. In some examples of the present disclosure, the instructions can be further executed to receive at least one of the number of market constraints on at least one of the product price and a market share.

A pricing module 382 can comprise CRI 384 and can be executed by the processing resources 372 to determine a price for the product based on the market price sensitivity of the product, the cost of the product, the utility of the product, and the number of market constraints. In a number of embodiments, prices for a number of products can be determined based on the market price sensitivity of the products, the costs of the products, the utilities of the products, and the number of market constraints. In some embodiments, the pricing module 382 can comprise CRI 384 and can be executed by the processing resources 372 to increase a total profit for the product and/or products, such that it exceeds a profit threshold (e.g., maximizes a profit). The instructions can also include instructions to determine a price for the product and/or products utilizing a transformed objective function with respect to a market share.

A mapping module (not pictured) can comprise CRI 384 and can be executed by the processing resources 372 to determine a one-to-one mapping between the product price and a product market share vector utilizing a Multinomal Logit (MNL) model, and a reformulation module (not pictured) can comprise CRI 384 and can be executed by the processing resources 372 to reformulate a profit function in the market share vector under the MNL model, wherein a price bound of the profit function is rewritten as at least one of the number of market constraints in the market share vector.

In some examples of the present disclosure, the instructions can be executable to determine an adjusted markup of a product and determine a market share of the product corresponding to the adjusted markup. The instructions can be further executable to price the product based on the adjusted markup of the product and the market share of the product. In some embodiments, the adjusted markup is constant at optimality for the product.

The instructions can be executable to determine the adjusted markup of the product include instructions to determine the adjusted markup of the product based on an original price of the product, a product cost, and a price coefficient. The instructions can further be executable to price the product using an optimization model in a single-dimensional space. In a number of embodiments, the instructions can be executable to price the product using an optimization model in a single-dimensional space rather than an optimization model in a in a multidimensional space.

A non-transitory CRM 376, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 376 can be integral, or communicatively coupled, to a computing device, in a wired and/or a wireless manner. For example, the non-transitory CRM 376 can be an internal memory, a portable memory, a portable disk, or a memory associated with another computing resource (e.g., enabling CRIs 384 to be transferred and/or executed across a network such as the Internet).

The CRM 376 can be in communication with the processing resources 372 via a communication path 386. The communication path 386 can be local or remote to a machine (e.g., a computer) associated with the processing resources 372. Examples of a local communication path 386 can include an electronic bus internal to a machine (e.g., a computer) where the CRM 376 is one of volatile, non-volatile, fixed, and/or removable storage medium in communication with the processing resources 372 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 386 can be such that the CRM 376 is remote from the processing resources, (e.g., processing resources 372) such as in a network connection between the CRM 376 and the processing resources (e.g., processing resources 372). That is, the communication path 386 can be a network connection. Examples of such a network connection can include a local area network (LAN), wide area network (WAN), personal area network (PAN), and the Internet, among others. In such examples, the CRM 376 can be associated with a first computing device and the processing resources 372 can be associated with a second computing device (e.g., a Java® server). For example, a processing resource 372 can be in communication with a CRM 376, wherein the CRM 376 includes a set of instructions and wherein the processing resource 372 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

1. A computer-implemented method for product pricing, comprising:
determining, using a processor, an initial market attraction value, a market price sensitivity, and cost information for a product, wherein the initial market attraction value includes a customer desire to purchase the product;
in response to receiving a market constraint with respect to the product, determining, using the processor, a first adjusted markup of the product;
in response to receiving no market constraint with respect to the product, determining a second adjusted markup of the product; and
determining, using the processor, a price for the product based on the initial market attraction value, the market price sensitivity, the cost information, the market constraint, and at least one of the first and the second adjusted markup of the product.

2. The method of claim 1, wherein determining the price for the product includes:
determining a one-to-one mapping between a number of potential prices for the product and a market-share vector under a Multinomial Logit (MNL) model;
formulating a profit function in the market share vector under the MNL model; and
determining, from the number of potential prices, the price for the product utilizing the formulated profit function.

3. The method of claim 1, wherein determining the price for the product includes determining a price that increases a total profit of the product.

4. The method of claim 1, wherein the market constraint includes a market share constraint.

5. The method of claim 1, wherein the market constraint includes a market price constraint.

6. The method of claim 1, wherein the market constraint includes a product quantity constraint.

7. The method of claim 1, wherein the initial market attraction is determined based on at least one of sales data, customer behavior data, and product variety data.

8. The method of claim 1, further comprising at least one of increasing a total market share of a first firm and decreasing a competitive firm's total profit, wherein increasing the total market share of the first firm and decreasing the competitive firm's total profit are equivalent subject to the market constraint.

9. A non-transitory computer-readable medium storing a set of instructions executable by a processing resource to:
determine an adjusted markup of a product;
determine a market share of the product corresponding to the adjusted markup; and
determine a price for the product based on the adjusted markup of the product and the market share of the product.

10. The non-transitory computer-readable medium of claim 9, wherein the instructions executable to determine the adjusted markup of the product include instructions to determine the adjusted markup of the product based on an original price of the product, a product cost, and a price coefficient.

11. The non-transitory computer-readable medium of claim 9, wherein the adjusted markup is constant at optimality for the product.

12. The non-transitory computer-readable medium of claim 9, wherein the instructions executable to determine a price for the product include instructions to determine the price using an optimization model in a single-dimensional space.

13. The non-transitory computer-readable medium of claim 9, wherein the instructions are further executable to:
transform a multi-product optimization model to a single-variable optimization model, wherein the single-variable optimization model is unimodal in the adjusted markup; and
utilize the single-variable optimization model to determine a price for the product.

14. A system for product pricing, comprising:
a memory resource;
a processing resource coupled to the memory resource to implement;
a determination module to determine a market price sensitivity, a cost, and a market utility of a product;
a market constraint module to receive a number of market constraints with respect to the product; and
a pricing module to determine a price for the product based on the market price sensitivity of the product, the cost of the product, the utility of the product, and the number of market constraints, the determined product price resulting in a total profit that exceeds a profit threshold.

15. The system of claim 14, wherein the market constraint module is configured to receive at least one of the number of market constraints on at least one of the determined product price and a market share.

16. The system of claim 14, further comprising:
a mapping module to determine a one-to-one mapping between the determined product price and a product market share vector utilizing a Multinomal Logit (MNL) model; and
a reformulation module to reformulate a profit function in the market share vector under the MNL model,
wherein a price bound of the profit function is rewritten as at least one of the number of market constraints in the market share vector.

17. The system of claim 14, wherein the pricing module is configured to determine a price for the product utilizing a transformed objective function with respect to a market share.

18. The method of claim 1, wherein determining the first adjusted markup of the product comprises:
determining the first adjusted markup based on an original price of the product, a product cost, and a price coefficient,
wherein the first adjusted markup of the product is not constant at optimality for the product.

19. The method of claim 1, wherein determining the second adjusted markup comprises:
determining the second adjusted markup based on an original price of the product, a product cost, and a price coefficient,
wherein the second adjusted markup of the product is constant at optimality for the product.
